(19) United States
(12) Patent Application Publication
(10) Pub. No.: US 2026/0359993 A1
(43) Pub. Date: Nov. 12, 2026

(54) CALIBRATION METHOD FOR REMOTE CRACK MEASUREMENT DEVICE

(71) Applicant: Research Institute of Highway Ministry of Transport, Beijing (CN)

(72) Inventors: Jinning ZHANG, Beijing (CN); Yue LIU, Beijing (CN); Yishu ZHOU, Beijing (CN); Hongbo GUO, Beijing (CN); Yingchao LUO, Beijing (CN); Lishuo REN, Beijing (CN)

(21) Appl. No.: 19/536,734

(22) Filed: Feb. 11, 2026

(30) Foreign Application Priority Data
May 7, 2025 (CN) 202510579285.7

(51) Int. Cl. G06T 7/246

(52) U.S. Cl. CPC G06T 7/246

(57) ABSTRACT

A calibration method for a remote crack measurement device includes: obtaining geometric parameter information of building cracks; determining at least one standard crack model based on the geometric parameter information of building cracks; fabricating a crack module corresponding to each standard crack model based on each standard crack model, and constructing a physical crack sample library based on the crack modules; selecting a target crack module from the physical crack sample library, and detecting the target crack module with the remote crack measurement device to obtain first crack detection data; detecting the target crack module with a standard detection device to obtain second crack detection data, where the detection accuracy of the standard detection device is higher than that of the remote crack measurement device; determining the detection error of the remote crack measurement device based on the first crack detection data and the second crack detection data.

### CROSS-REFERENCE TO RELATED APPLICATION

This application claims priority to China Patent Application 202510579285.7, filed on May 7, 2025, which is incorporated herein by reference.

### TECHNICAL FIELD

The present disclosure relates to the technical field of crack detection, and particularly to a calibration method for a remote crack measurement device.

### BACKGROUND

Building surface cracks are a type of building defect, often influenced by factors such as building settlement, fatigue stress, thermal expansion and contraction, and external loads, leading to the appearance of cracks on the structural surface.

Currently, crack detection technology has become the mainstream method due to its non-contact and high-efficiency characteristics. In the actual operation process, high-resolution imaging equipment is usually used to obtain crack images, which are then processed and analyzed in digital format. However, the resolution of the images obtained by current imaging equipment mostly can only reach the 0.1 mm level. When dealing with detection tasks of micro-cracks, it is difficult to meet the precise measurement requirements of micro-cracks smaller than 0.05 mm, resulting in significant errors in the identification of micro-cracks and failing to meet the measurement requirements of precise scenarios, thus causing considerable errors in the geometric parameters of the measured cracks.

### SUMMARY

In order to solve the above technical problems, the present application provides a calibration method for a remote crack measurement device.

The calibration method for the remote crack measurement device provided by the present application includes:
obtaining geometric parameter information of building cracks;
determining at least one standard crack model based on the geometric parameter information of the building cracks;
fabricating a crack module corresponding one-to-one to each standard crack model based on each standard crack model, and constructing a physical crack sample library based on the crack modules;
selecting a target crack module from the physical crack sample library, and detecting the target crack module with the remote crack measurement device to obtain first crack detection data;
detecting the target crack module with a standard detection device to obtain second crack detection data, the detection accuracy of the standard detection device is higher than that of the remote crack measurement device; and
determining a detection error of the remote crack measurement device based on the first crack detection data and the second crack detection data.

In some embodiments of the present application, the step of obtaining geometric parameter information of the building cracks includes: conducting a
preliminary scan of a building with an image recognition sensor carried by an unmanned aerial vehicle to obtain a preliminary scan image; performing crack recognition on the preliminary scan image with an image recognition sensor carried by the unmanned aerial vehicle to determine a crack area; and
scanning the crack area with a laser measuring instrument carried by the unmanned aerial vehicle to obtain the geometric parameter information of the building cracks.

In some embodiments of the present application, the step of determining at least one standard crack model based on the geometric parameter information of the building cracks includes: performing data fitting processing on a plurality of geometric parameter information of the building cracks to obtain at least one standard crack model, and one standard crack model is obtained by data fitting of the plurality of geometric parameter information of the building cracks.

In some embodiments of the present application, the data fitting processing includes any one or any combination of linear regression fitting processing, polynomial fitting processing, spline interpolation fitting processing, surface fitting processing, and least squares fitting processing.

In some embodiments of the present application, the step of detecting the target crack module with the remote crack measurement device to obtain first crack detection data includes: detecting the first crack width, first crack length, first crack depth and first crack position coordinates of the target crack module with the remote crack measurement device; and determining the first crack detection data based on the first crack width, the first crack length, the first crack depth and the first crack position coordinates.

In some embodiments of the present application, the step of detecting the target crack module with the standard detection device to obtain second crack detection data includes: detecting second crack width, second crack length, second crack depth and second crack position coordinates of the target crack module with the standard detection device; and determining the second crack detection data based on the second crack width, the second crack length, the second crack depth and the second crack position coordinates.

In some embodiments of the present application, the crack module includes a first type of crack module, the first type of crack module is an integrated structure, the first crack module is provided with a complete crack, and the first type of crack module is dimensionally matched with the standard detection device.

In some embodiments of the present application, the crack module includes a second type of crack module, which comprises a plurality of module units. Each module unit is provided with a crack unit and when the plurality of module units are assembled, the plurality of crack units are assembled into a complete crack, and the module unit is dimensionally matched with the standard detection device.

In some embodiments of the present application, the remote crack measurement device includes an unmanned aerial vehicle, and the standard detection device includes a three-coordinate measuring instrument and an industrial microscope.

In some embodiments of the present application, the manufacturing method of the crack module include any one or any combination of three-dimensional printing, precision machining, and three-axis computer numerical control machining.

The calibration method for the remote crack measurement device provided by the present application has at least the following advantages:
The calibration method for the remote crack measurement device provided by the present application, by collecting the geometric parameters of actual cracks to establish a standard crack model, ensures that the calibration covers a variety of crack types, avoiding the limitations of a single scenario. The mathematical model is transformed into a solid crack module, creating a real environment for repeatable testing. Based on the detection data of high-precision standard detection device, the error of remote measurement crack device is calibrated to ensure the authority of comparison. By comparing the first crack detection data with the second crack detection data, the detection error of the remote crack measurement device can be determined, ensuring the authenticity of the detection error and improving the applicability, accuracy, and precision of the error detection method.

### BRIEF DESCRIPTION OF THE DRAWINGS

A brief introduction will be given to the accompanying drawings required for the description of the embodiments to illustrate the technical solution in the embodiments of the present application definitely. It is obvious that the accompanying drawings described below are only some embodiments of the present application. For those skilled in the art, other drawings can be obtained based on these drawings without creative efforts.

FIG. 1 is a flowchart of the calibration method for the remote crack measurement device according to an exemplary embodiment.

### DETAILED DESCRIPTION

The technical solutions in the embodiments of the present disclosure are described below clearly and completely referring to the accompanying drawings in the embodiments of the present disclosure. Apparently, the described embodiments are merely some rather than all of the embodiments of the present disclosure. All other embodiments obtained by those skilled in the art based on the embodiments of the present disclosure without creative efforts should fall within the protection scope of the present disclosure.

Referring to "embodiments" in the present disclosure means that specific features, structures, or characteristics described in conjunction with the embodiments can be included in at least one embodiment of the present invention. The phrase appearing in various positions in the manual does not necessarily refer to the same embodiment, nor is it an independent or alternative embodiment that is mutually exclusive with other embodiments. Technicians in this field explicitly and implicitly understand that the embodiments described in the present disclosure can be combined with other embodiments.

Building surface crack is a type of building defect, often affected by building settlement, fatigue stress, thermal expansion and contraction, and external loads, resulting in cracks on the surface of the structure.

Currently, crack detection technology has become the mainstream method due to its non-contact and high-efficiency characteristics. In the actual operation process, high-resolution imaging equipment is usually used to obtain crack images, which are then processed and analyzed in digital format. However, the resolution of the images obtained by current imaging equipment mostly can only reach the 0.1 mm level. When dealing with detection tasks of micro-cracks, it is difficult to meet the precise measurement requirements of micro-cracks smaller than 0.05 mm, resulting in significant errors in the identification of micro-cracks and failing to meet the measurement requirements of precise scenarios, thus causing considerable errors in the geometric parameters of the measured cracks.

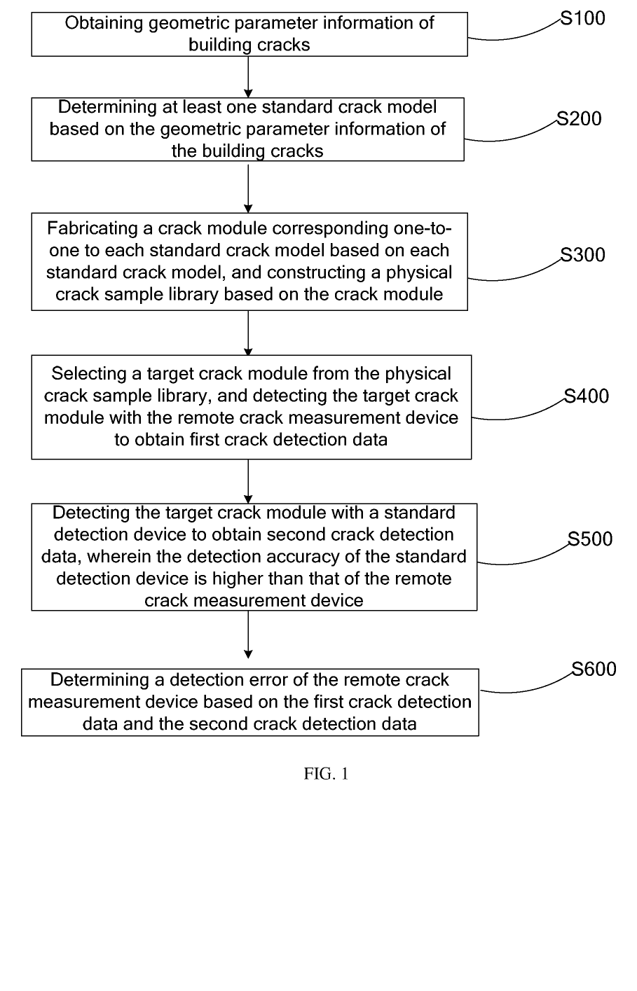

The following will further describe the embodiment of the present application with reference to FIG. 1.

To solve the above technical problems, the present application provides a calibration method for a remote crack measurement device. By collecting the geometric parameters of actual cracks to establish a standard crack model, ensures that the calibration covers a variety of crack types, avoiding the limitations of a single scenario. The mathematical model is transformed into a solid crack module, creating a real environment for repeatable testing. Based on the detection data of high-precision standard detection device, the error of remote measurement crack device is calibrated to ensure the authority of comparison. By comparing the first crack detection data with the second crack detection data, the detection error of the remote crack measurement device can be determined, ensuring the authenticity of the detection error and improving the applicability, and accuracy of the error detection method.

An exemplary embodiment of the present application provides a calibration method for a remote crack measurement device, as shown in FIG. 1. The calibration method for the remote crack measurement device includes:

S100: Obtaining geometric parameter information of building cracks.

In step S100, an unmanned aerial vehicle equipped with an image sensor can be used to conduct a preliminary scan of the building to obtain a preliminary scan image. Then, an image recognition sensor can be used to identify cracks in the preliminary scan image to determine a crack area. Subsequently, a laser measurement instrument can be used to scan the crack area to measure the actual building cracks and obtain real crack samples of geometric parameter data such as crack widths, depths, lengths, orientations, and positions information of various cracks. A three-dimensional digital model of the cracks is generated by a point cloud processing software, and key geometric parameter data, such as crack width, depth, length, and position information, is extracted to form the geometric parameter information of the building cracks. In this way, the geometric parameter information can cover the geometric parameters of the vast majority of cracks, ensuring the completeness of the collection of the geometric parameter information of the cracks. Based on actual building data for modeling, it can avoid the deviation caused by theoretical assumptions, combines the surface and internal parameters of the crack, covers the full-dimensional features of the crack, and builds a real test environment.

S200: Determining at least one standard crack model based on the geometric parameter information of the building cracks.

In step S200, the geometric parameter information of the building cracks can be processed through data fitting to establish a more comprehensive and accurate standard crack model. Additionally, big data and AI simulation technology can be utilized to process the standard crack model to form a standard two-dimensional or three-dimensional crack model. By integrating crack data of different shapes and sizes, the constructed model can adapt to a wider range of building crack scenarios and avoid overfitting problems caused by single crack fitting. A unified model based on multi-crack fitting can calibrate the detection capability of the remote crack measurement device for different types of cracks at one time.

S300: Based on each standard crack model, fabricating a crack module corresponding one-to-one with to each standard crack model, and constructing a physical crack sample library based on the crack modules.

In step S300, the standard crack models are imported into a manufacturing software, and a processing method is selected based on material properties (such as concrete, metal, composite materials) and crack complexity, such as 3D printing, three-axis computer numerical control (CNC), or precision casting, to generate a crack module corresponding one-to-one to each standard crack model. Then, a physical crack sample library is constructed based on the crack modules. The physical crack sample library can cover all types of cracks and be suitable for different scenarios such as bridges, tunnels, and ancient buildings. This enables the crack modules to simulate different crack scenarios, improving the authenticity and accuracy of the calibration of remote crack measurement device. By collecting the geometric parameters of actual cracks to establish standard models, the calibration can cover a diverse range of crack types, avoiding the limitations of a single scenario. The mathematical model is transformed into an entitative crack module, creating a repeatable test environment. Based on the detection data of high-precision standard device, the error of the remote measurement crack device is calibrated to ensure the authority of comparison.

S400: Selecting a target crack module from the physical crack sample library, and detecting the target crack module with the remote crack measurement device to obtain first crack detection data.

In step S400, a target crack module is selected from the physical crack sample library, where the target crack module is suitable for demonstrating the crack type to be measured in reality. The target crack module is detected with the remote crack measurement device, for example, by using an unmanned aerial vehicle equipped with an image sensor, an image recognition sensor, and a laser measurement instrument to scan the crack area, and obtaining the geometric parameter information of the crack in the target crack module. By selecting the target crack module that highly matches the type of cracks in the building being tested, the actual detection environment is replicated to verify the performance of the remote crack measurement device in real scenarios.

S500: Detecting the target crack module with a standard detection device to obtain second crack detection data, wherein the detection accuracy of the standard detection device is higher than that of the remote crack measurement device.

In step S500, the standard detection device can be one of industrial microscopes or industrial coordinate measuring machines, which can be used to assign values to the geometric parameter information of the cracks with an accuracy of up to 0.003 mm. It can also be verified through multi-sensor fusion, for example, by simultaneously measuring with an industrial microscope and an industrial coordinate measuring machine to ensure the absolute credibility of the reference data. Different sensors have different measurement principles and advantages. By comparing and analyzing their measurement results, they can verify each other and eliminate errors and interference factors in the measurement process. The geometric parameter information of the target crack module is calibrated by high-precision standard inspection equipment to obtain the second crack detection data. The second crack detection data serves as high-precision standard data, providing standard data for the performance verification of the remote crack measurement device, thereby making the error calculation more reliable.

S600: Determining a detection error of the remote crack measurement device based on the first crack detection data and the second crack detection data.

The first crack detection data of the target crack module is directly measured by the remote crack measurement device, and then the target crack module is detected by the standard detection device to obtain the second crack detection value. The second crack detection data is used as the reference value of the benchmark. By calculating the absolute error and relative error between the first crack detection data and the second crack detection data, the maximum allowable error is set. The root cause of hardware or software problems can be identified through error decomposition, for example, using error data to train AI models (such as regression models) to automatically compensate for environmental interference (such as metal expansion errors caused by temperature). This further improves the accuracy and precision of the remote crack measurement device. By comparing the first crack detection data measured by the remote crack measurement device with the second crack detection data measured by the standard detection device, the accuracy and reliability of the remote crack measurement device in various parameter measurements can be intuitively evaluated. For example, if there is a significant deviation between the crack width measured by the remote crack measurement device and the second crack detection data, it indicates that the device has performance issues in width measurement and needs to be calibrated or optimized.

In some embodiments of the present application, the step S100 of obtaining geometric parameter information of building cracks includes:

S101: Conducting a preliminary scan of a building with an image sensor carried by an unmanned aerial vehicle to obtain a preliminary scan image.

Based on a building CAD model or a satellite map, a three-dimensional grid flight path is generated to ensure coverage of the building to be detected. The unmanned aerial vehicle flies automatically along a preset path, reducing redundant waypoints. The image sensor continuously captures images at a preset frequency and transmits them in real time to the ground station. The ground station software checks the image quality in real time and automatically marks areas that need to be rephotographed. Additionally, the parameters of the image sensor, such as focal length and exposure time, are adjusted to ensure clear and accurate images can be obtained under different lighting conditions. This can improve the collection efficiency, avoid blind spots in manual inspection, quickly generate a building surface health heat map, and mark potential hazard areas. It enhances the efficiency of building crack detection and avoids invalid data entering the subsequent analysis process through real-time image quality checks, reducing the waste of computing resources.

S102: Performing crack recognition on the preliminary scan image with an image recognition sensor carried by the unmanned aerial vehicle to determine a crack area.

The preliminary scanned images in step S101 are analyzed frame by frame with the image recognition sensor to identify the crack pixel regions, and a binary mask image is output. Combined with the 3D point cloud coordinates, the cracks are mapped to the real coordinate system of the building to obtain the crack coordinates. By fusing pixels and point clouds, the accuracy of crack location is improved, the crack regions are automatically marked, the workload of manual labeling is reduced, and the model training and optimization of image recognition sensor are carried out to improve the accuracy and robustness of crack recognition.

S103: Scanning the crack area with a laser measuring instrument carried by the unmanned aerial vehicle to obtain the geometric parameter information of the building cracks.

Based on the crack coordinates in step S102, the close flight path of the UAV is planned, the scan line density is set, and the laser measuring instrument is activated to scan the building to collect the 3D point cloud of the cracks and synchronously record the environmental parameters for data compensation. For the various collected data, image processing software and data analysis algorithms are used to obtain the geometric parameter information of the building cracks. Wherein, for image data, edge detection algorithms (such as the Canny edge detection algorithm) can be used to identify the contour boundaries of the cracks, and calculate the length, width, and orientation angle of the cracks. Combined with 3D laser scanning data, point cloud processing techniques are utilized to precisely measure the depth, surface roughness, and curvature of the cracks in 3D space. For example, when measuring the crack length, the points on the crack contour can be fitted to obtain the centerline of the crack, and then the length of the centerline is calculated. When measuring the crack width, multiple positions on the cross-section of the crack are selected for measurement, and the average value is taken as the width of the crack. The extracted geometric parameter information is organized and classified to form a detailed database of building crack geometric parameters, providing a data foundation for subsequent crack morphology screening and data fitting processing. Additionally, the laser measuring instrument is calibrated to eliminate measurement errors and ensure the reliability of the measurement data.

In some embodiments of the present application, the step S200 of determining at least one standard crack model based on the geometric parameter information of the building cracks includes: performing data fitting processing on the plurality of geometric parameter information of the building cracks to obtain at least one standard crack model, where one standard crack model is obtained by data fitting of the plurality of geometric parameter information of the building cracks. Wherein, the plurality of collected crack morphologies are preliminarily screened, and those with consistent morphologies are classified as the same type of cracks for data fitting processing. Wherein, the cosine similarity algorithm can be used to calculate the similarity of the crack orientation angles, and the Euclidean distance can be used to calculate the similarity of numerical parameters such as crack length and width. For each geometric parameter, corresponding weights are set based on the influence of each parameter on the crack morphology. The similarity values of each parameter are weighted and summed to obtain the comprehensive similarity score of the crack morphology. A similarity threshold is set, and when the comprehensive similarity score of two cracks is higher than this threshold, it is considered that the two cracks have the same morphology and can be classified as the same type of crack.

Then, data fitting processing is performed on each type of crack. Specifically, based on the geometric parameter information of each original building crack, a plurality of geometric parameter information is divided into a plurality of first initial data sets, and each first initial data set corresponds to a preset crack region. The first initial data set corresponding to the target crack region is determined as the first target data set, and the geometric parameters in the first target data set are subjected to data fitting processing to obtain at least one standard crack model. Specifically, appropriate mathematical models and fitting algorithms are used to perform data fitting processing on the geometric parameters in the first target data set. Common fitting methods for crack orientation and morphology include polynomial fitting, spline curve fitting, etc.. For example, regarding the change in the direction of cracks, if it shows a relatively smooth curve feature, the cubic spline curve fitting method can be adopted. By using the known coordinates of the crack direction points, a smooth curve that accurately describes the crack direction can be fitted. When fitting the parameters such as the length and width of the cracks, considering that the crack parameters may have certain distribution patterns, the probability distribution fitting method can be used. Assuming that the crack length follows a normal distribution, through statistical analysis of the crack length data in the first target data set, the mean and standard deviation can be calculated, and then the parameters of the normal distribution can be determined to obtain the probability distribution model of the crack length.

Among them, the data fitting processing method can adopt any one or any combination of linear regression fitting processing, polynomial fitting processing, spline interpolation fitting processing, surface fitting processing, and least squares fitting processing as the fitting method for the plurality of geometric parameter information of the building cracks. This can take advantage of the strengths of each fitting processing method to fit a large amount of raw data, making the standard crack model have a strong fitting effect and meet different scene requirements. It can be applied to different crack detections, allowing the standard crack model to calibrate a wide range of crack types and avoid the limitations of a single scene. By comprehensively applying multiple fitting methods, the geometric parameters of the building cracks can be comprehensively fitted, and ultimately at least one standard crack model that accurately describes the typical crack morphology of the target crack area can be obtained. This standard crack model not only includes the main geometric feature parameters of the crack but also reflects the morphological distribution pattern of the crack in the target area, providing an important reference basis for subsequent building structure safety assessment, crack cause analysis, repair scheme design, and calibration of remote crack measurement device. In addition, the mathematical model is transformed into an entitative crack module, and a real environment for repeatable testing is constructed. The detection data of high-precision standard device is used as the benchmark to calibrate the error of remote crack measurement device, ensuring the authority of the comparison.

In some embodiments of the present application, the step S400 of detecting the target crack module with the remote crack measurement device to obtain the first crack detection data includes:
detecting the first crack width, first crack length, first crack depth and first crack position coordinates of the target crack module through the remote crack measurement device;
determining the first crack detection data based on the first crack width, first crack length, first crack depth and first crack position coordinates.

The target crack module is selected in the physical crack sample library. When selecting the target crack module, it is necessary to closely combine the type of crack to be measured. The target crack module is suitable for demonstrating the type of crack to be measured. The target crack module is detected with the remote crack measurement device. For example, scanning the crack area with an image sensor, an image recognition sensor and a laser measuring instrument carried by an unmanned aerial vehicle. The image sensor carried on the unmanned aerial vehicle has high-resolution imaging capabilities and can clearly capture the surface texture, morphological details and other information of the crack; the image recognition sensor uses image recognition algorithms to automatically identify the crack area and extract key features of the crack, such as the edge contour; the laser measuring instrument is used to accurately measure the geometric parameters of the cracks, such as width and depth. Wherein, the first crack detection data includes the first crack width, first crack length, first crack depth and first crack position coordinates of the target crack module. By selecting a target crack module that highly matches the type of building crack to be measured, the actual detection environment is reproduced to verify the performance of the remote crack measurement device in real scenarios. By using the remote crack measurement device to obtain the first crack width, length, depth and position coordinates and other data, and comparing them with the standard values measured by high-precision standard device, the error size of the remote crack measurement device in various parameter measurements can be accurately calculated, including absolute error and relative error. For example, if the first crack width measured by the laser measurement instrument has a large deviation from the standard value, it can be clearly determined that the device has a precision problem in width measurement, and then the equipment can be calibrated and optimized in a targeted manner. Based on the first crack detection data, the image recognition algorithm can be optimized. When the image recognition sensor extracts key features such as the crack edge contour, there may be inaccurate recognition or omission. By analyzing a large amount of first crack detection data, the performance of the algorithm under different crack shapes and lighting conditions can be understood, the causes of recognition errors can be identified, and then the parameters of the algorithm can be adjusted or the algorithm model can be improved to increase the accuracy and robustness of crack recognition. For example, if it is found that the algorithm performs poorly in identifying small cracks, the performance of the algorithm can be enhanced by increasing the number of training samples or optimizing the feature extraction method. Then, the geometric parameter information of the target crack module can be calibrated using high-precision standard detection device to provide standard data for the remote crack measurement device, thereby making the error calculation more reliable.

In some embodiments of the present application, the step S500 of detecting the target crack module through standard detection equipment to obtain the second crack detection data includes:
detecting the second crack width, second crack length, second crack depth and second crack position coordinates of the target crack module with a standard detection device;
determining the second crack detection data based on the second crack width, second crack length, second crack depth and second crack position coordinates.

The standard detection device can use industrial microscopes and industrial three-coordinate measuring machines to assign values to the geometric parameter information of the cracks, with an accuracy of up to 0.003 mm. To improve the accuracy and reliability of the measurement of the crack geometric parameters, multi-sensor fusion cross-validation can also be used, for example, industrial microscopes and industrial three-coordinate measuring machines can be used for measurement simultaneously to ensure the absolute credibility of the benchmark data. Different sensors have different measurement principles and advantages. By comparing and analyzing their measurement results, they can verify each other and eliminate errors and interference factors in the measurement process. The geometric parameter information of the target crack module is calibrated using high-precision standard detection device to obtain the second crack detection data, providing standard data for the remote crack measurement device, thereby making the error calculation more reliable. Exemplarily, when performing multi-sensor fusion cross-validation, the industrial microscope is first used to conduct a preliminary observation and measurement of the crack, obtaining the microscopic image and some geometric parameter information of the crack. Then, the industrial three-coordinate measuring machine is used to measure the same position of the crack to obtain the three-dimensional coordinate data and more precise geometric parameters of the crack. The measurement results of the two sensors are compared, if the error between them is within the allowable range, it can be considered that the measurement result is reliable; if the error is large, the reasons need to be further analyzed, which may be due to improper measurement methods, sensor failures, or crack surface characteristics, etc., and then corresponding measures should be taken to correct and remeasure.

The second crack detection data, as high-precision standard data, provides an accurate reference for the performance verification of the remote crack measurement device. By comparing the first crack detection data measured by the remote crack measurement device with the second crack detection data measured by the standard detection device, the accuracy and reliability of the remote crack measurement device in various parameter measurements can be evaluated intuitively. For example, if there is a large deviation between the crack width measured by the remote crack measurement device and the second crack detection data, it indicates that there is a performance issue in the width measurement of the device, and calibration or optimization is needed.

In some embodiments of the present application, the crack module includes a first type of crack module, which is an integrated structure. The first crack module has a complete crack, and the first type of crack module is dimensionally matched with the standard detection device. In this embodiment, the module is a single-piece integral structure, with a complete and continuous crack without any breaks, and its dimensions are strictly matched with the standard detection device. It is formed in one piece through 3D printing, CNC machining or precision casting, ensuring a high degree of consistency between the crack geometric parameters (such as width, depth, length, etc.) and the actual situation. The first crack module can be directly placed on the worktable of the standard detection device without assembly or adjustment, reducing human operation errors. Moreover, there are no moving parts or seams, and it is less prone to deformation or wear during long-term use. This ensures that the data obtained by the remote crack measurement device has high continuity and integrity. For example, when using a laser measuring instrument to measure the depth of a crack, a complete crack can ensure the continuous propagation of the measurement light within the crack, thereby obtaining accurate depth data.

In some embodiments of the present application, the crack module includes a second type of crack module, which comprises multiple module units, each of which is provided with a crack unit. When the plurality of module units are assembled, the plurality of crack units form a complete crack, and the module units are dimensionally matched with the standard detection device. In this embodiment, it is composed of several independent module units (for example, with a size of 50 mm × 50 mm), each unit containing a local crack, which form a complete crack after splicing (such as a total length of 1 m crack). Each unit is processed separately, and the interfaces are designed as mortise and tenon, magnetic attraction or precision guide rails to ensure assembly accuracy. By adding or reducing module units, the length (for example, extending the crack length from 0.5 m to 3 m), shape (such as straight, zigzag, or mesh) of the crack can be dynamically adjusted to adapt to different detection scenarios. Different types of crack units (such as a 0.1 mm width unit + a 5 mm depth unit) can be combined to simulate complex cracks in real buildings.

In some embodiments of the present application, the remote crack measurement device includes an unmanned aerial vehicle, and the standard detection device includes a three-coordinate measuring instrument and an industrial microscope. In this embodiment, the remote crack measurement device can use an unmanned aerial vehicle equipped with an image sensor, an image recognition sensor, and a laser measuring instrument to scan the crack area, obtaining the geometric parameter information of the building crack. The unmanned aerial vehicle can fly to high altitudes, narrow or dangerous areas, and quickly scan large surface areas through an image sensor (RGB camera), while the laser measuring instrument synchronously acquires three-dimensional point cloud data of the crack, improving data collection efficiency. The geometric parameter measurement accuracy of the target crack module by the three-coordinate measuring instrument can reach ± 0.001 mm, and the industrial microscope can magnify 1000 times to observe the roughness of the crack edge and microscopic crack bifurcations, assisting in determining the cause of the crack. The measurement results of the standard detection device are used as a standard to calibrate the unmanned aerial vehicle data, allowing for precise calculation of the system error of the unmanned aerial vehicle and targeted correction of sensor parameters. A traceable measurement value traceability chain is established, and the unmanned aerial vehicle measurement data is traced back to national or international standards (such as ISO certification) through the standard detection device, ensuring the legal effect and cross-platform comparability of the detection results. Through the process of laboratory standard detection device - unmanned aerial vehicle calibration - on-site detection - laboratory standard detection device re-measurement, a technical closed loop is formed to continuously verify the performance stability of the unmanned aerial vehicle.

In some embodiments of the present application, the generation methods of the crack module include three-dimensional printing, precision machining, and three-axis computer numerical control (CNC) processing, or any combination thereof. It can be understood that in generating the crack module, any one or any combination of three-dimensional printing, precision machining, and three-axis CNC processing can be adopted. Among them, three-dimensional printing can generate complex shapes such as internal cavities and bifurcated cracks that are difficult to achieve through traditional processing. By changing the printing material, the crack characteristics of different base materials such as concrete, metal, and plastic can be simulated. Precision machining (traditional mechanical processing) directly uses engineering materials for processing and can retain the original mechanical and thermal properties. Mechanical processing can achieve dimensional accuracy of ± 0.01 mm, making it suitable for calibrating high-sensitivity detection device and for producing a small number of high-precision standard crack modules. Three-axis CNC processing can automatically process and produce dozens of modules per hour, suitable for large-scale calibration needs. Three-axis linkage can process moderately complex shapes such as inclined cracks and wavy edges, ensuring that the geometric parameters of all modules are highly uniform.

In another embodiment, after the step S300 of making crack modules corresponding one-to-one to each standard crack model based on each standard crack model, the process further includes: conducting process error detection on the generated crack modules to determine the dimensional error of the crack data of the crack modules caused by the processing technology; and detecting the crack modules with a dimensional error less than a preset error through standard detection device. Thus, by screening out the crack templates with errors greater than the preset error, the transmission of processing errors to subsequent inspection stages is avoided, which can save detection costs and improve detection efficiency.

It can be understood that when making crack modules corresponding one-to-one to each standard crack model based on the standard crack models, due to the limitations of the processing technology, there may be certain dimensional errors between the crack set parameter information in the generated crack modules and the standard crack models. To ensure the accuracy and reliability of subsequent inspection work and avoid interference to the detection results caused by the processing errors of the crack modules themselves, process error detection can be conducted on the generated crack modules to determine the error range of each crack module. For example, in the actual operation process, a high-precision three-dimensional scanning measurement device can be used to conduct a full scan of the crack modules. This device can capture every minute feature on the surface of the crack modules through extremely high resolution, generating detailed three-dimensional point cloud data. Subsequently, these point cloud data are precisely compared with the three-dimensional data of the pre-built standard crack models. Through existing data processing software, the deviation values of the crack modules from the standard crack models in various key dimensional parameters are calculated, thereby obtaining comprehensive dimensional error data. If the dimensional error is greater than the preset error, it indicates that the crack module has insufficient restoration of the geometric parameter information in the standard crack model, which may affect the subsequent calibration results. Based on the error detection results, the crack modules with a dimensional error less than the preset error are screened out as qualified modules that meet the detection requirements; while the crack modules with a dimensional error greater than the preset error are regarded as unqualified modules.

By conducting process error detection on the generated crack modules and screening out the crack modules that meet the requirements, the crack templates with larger processing errors can be removed at an early stage, avoiding the transmission of processing errors to subsequent detection stages. This helps save the additional detection costs incurred from detecting unqualified modules and significantly improves the overall detection efficiency. By detecting the crack modules that meet the requirements and comparing the first crack detection data with the second crack detection data, the detection error of the remote measurement crack device can be determined, ensuring the authenticity of the detection error and enhancing the applicability and accuracy of the error detection method. This ensures that the final detect results can truly and accurately reflect the performance characteristics of the crack modules.

The above-described content can be implemented separately or in various combinations, and all these variations are within the scope of protection of the present application.

It should be noted that in this document, relationship terms such as "first" and "second" are merely used to distinguish one entity or operation from another entity or operation, and do not necessarily imply any actual relationship or sequence between them. Moreover, the terms "including", "comprising", or any other variations are intended to cover non-exclusive inclusions, so that a process, method, article, or device that includes a series of elements not only includes those elements but also includes other elements not explicitly listed, or elements inherent to the process, method, article, or device. In the absence of further limitations, the phrase "including a..." The limited elements do not exclude the existence of other identical elements in the process, method, article or device including the elements.

Finally, it should be noted that the above embodiments are only used to illustrate the technical solution of the present application, and not to limit it. Although the present application has been described in detail with reference to the above embodiments, it should be understood by those skilled in the art that the technical solution recorded in each of the above embodiments can still be modified, or some of the technical features can be replaced with equivalent features; and these modifications or replacements do not depart from the spirit and scope of the technical solution of each embodiment of the present application.

1. A calibration method for a remote crack measurement device, comprising:
obtaining geometric parameter information of building cracks;
determining at least one standard crack model based on the geometric parameter information of the building cracks, wherein the step of determining at least one standard crack model based on the geometric parameter information of the building cracks comprises: performing data fitting processing on a plurality of the geometric parameter information of the building cracks to obtain at least one standard crack model, wherein one standard crack model is obtained by data fitting of the plurality of the geometric parameter information of the building cracks;
fabricating a crack module corresponding one-to-one to each standard crack model based on each standard crack model, and constructing a physical crack sample library based on the crack module;
selecting a target crack module from the physical crack sample library, and detecting the target crack module with the remote crack measurement device to obtain first crack detection data, wherein a method of detecting the target crack module with the remote crack measurement device to obtain first crack detection data comprises: obtaining an image of a target area with an image sensor carried by an unmanned aerial vehicle; scanning the image of the target area with an image recognition sensor carried by the unmanned aerial vehicle to automatically identify a crack area; detecting the target crack module with a laser measuring instrument carried by the unmanned aerial vehicle to obtain the first crack detection data, wherein the first crack detection data comprises a first crack width, a first crack length, a first crack depth and a first crack position coordinates of the target crack module;
detecting the target crack module with a standard detection device to obtain second crack detection data, wherein detection accuracy of the standard detection device is higher than that of the remote crack measurement device; and
determining a detection error of the remote crack measurement device based on the first crack detection data and the second crack detection data.

2. The calibration method for the remote crack measurement device according to claim 1, wherein the step of obtaining geometric parameter information of building cracks comprises:
conducting a preliminary scan of a building with the image sensor carried by the unmanned aerial vehicle to obtain a preliminary scan image;
performing crack recognition on the preliminary scan image with the image recognition sensor carried by the unmanned aerial vehicle to determine the crack area; and
scanning the crack area with the laser measuring instrument carried by the unmanned aerial vehicle to obtain the geometric parameter information of the building cracks.

3. The calibration method for the remote crack measurement device according to claim 1, wherein the data fitting processing comprises any one or any combination of linear regression fitting processing, polynomial fitting processing, spline interpolation fitting processing, surface fitting processing, and least squares fitting processing.

4. The calibration method for the remote crack measurement device according to claim 1, wherein the step of detecting the target crack module with the remote crack measurement device to obtain first crack detection data comprises:
detecting the first crack width, the first crack length, the first crack depth and the first crack position coordinates of the target crack module with the remote crack measurement device; and
determining the first crack detection data based on the first crack width, the first crack length, the first crack depth and the first crack position coordinates.

5. The calibration method for the remote crack measurement device according to claim 1, wherein the step of detecting the target crack module with a standard detection device to obtain second crack detection data comprises:
detecting a second crack width, a second crack length, a second crack depth and a second crack position coordinates of the target crack module with the standard detection device; and
determining the second crack detection data based on the second crack width, the second crack length, the second crack depth and the second crack position coordinates.

6. The calibration method for the remote crack measurement device according to claim 1, wherein the crack module comprises a first type of crack module, the first type of crack module is an integrated structure, the first type of crack module is provided with a complete crack, and the first type of crack module is dimensionally matched with the standard detection device.

7. The calibration method for the remote crack measurement device according to claim 6,
wherein the crack module comprises a second type of crack module, the second type of crack module comprises a plurality of module units, each of the plurality of module units is provided with a crack unit, wherein, the plurality of module units are in a spliced state, the plurality of crack units are assembled into the complete crack, and each of the plurality of module units is dimensionally matched with the standard detection device.

8. The calibration method for the remote crack measurement device according to claim 1, wherein the remote crack measurement device comprises the unmanned aerial vehicle, and the standard detection device comprises a three-coordinate measuring instrument and an industrial microscope.

9. The calibration method for the remote crack measurement device according to claim 1, wherein a manufacturing method of the crack module comprises any one or any combination of three-dimensional printing, precision machining, and three-axis computer numerical control processing.
